(19) United States
(12) Patent Application Publication
(10) Pub. No.: US 2008/0059891 A1
(43) Pub. Date: Mar. 6, 2008

(54) System and a method for improving digital media content using automatic process

(76) Inventor: Eyal Herzog, Tel Aviv (IL)

Correspondence Address: Eitan Law Group;c/o Landon IP Inc., Suite 450, 1700 Diagonal Road, Alexandria, VA, 22314, US

(21) Appl. No.: 11/513,017

(22) Filed: Aug. 31, 2006

(51) Int. Cl. G06F 3/00

(52) U.S. Cl. 715/751

(57) ABSTRACT

There is provided herein a method of post review of content items previously posted on a shared network resource, the method may include receiving a suggestion from a viewer with respect to a proposed change to a previously posted content item and submitting the suggestion to a control group for a ratification vote of the proposed change to the previously posted content item. There is also provided herein a system for post review of content items previously posted on a shared network resource, may include a media content sorter adapted to receive from one or more voters voting values for a proposed change in a previously posted content item and to replace a changed content item with the a previously posted content item if the voting values comply with a predefined policy.

### FIELD OF THE DISCLOSURE

The present disclosure relates to the field of digital multimedia content distribution and hosting on a data network. More specifically, the present disclosure relates to an automated peer review and control of digital multimedia content and distribution on a host site, as well as, a means for avoiding the storage and multiple postings of duplicate or similar digital multimedia content.

### BACKGROUND

The universal adoption of wide-band data networks, in particular the Internet, with improved availability of user wide-band access points has lead to wide spread transferring and distribution of data, including digital multimedia content. The wide-band data networks facilitate the fast and efficient movement of large digital multimedia files or content. As the technology (multimedia streaming) and forms (both fixed and mobile) of client access to wide-band data networks has advanced new methods for uploading, posting, and downloading digital multimedia files have evolved. The technological improvements in digital media and in the ways digital media can be accessed over the Internet have resulted in more and more digital content being submitted and consumed by millions of individual users and content/service providers through out the world. In particular, Technological improvements continue to facilitate the creation of a wide variety of digital multimedia content and services in audio, visual, and audiovisual content (hereinafter referred to collectively as “audiovisual content”) that are sent to customers through various media devices. Often, the ability to provide large amounts of digital multimedia content, and at the same time to maintain high quality of service (“QoS”), is limited by the need to monitor, evaluate, and/or manipulate the tremendous amount of available digital multimedia content in relatively very short time. The ability to provide large amounts of digital multimedia content is also limited by the inability to meet all clients' preferences or desires as to the digital multimedia content each one of them wishes to consume.

The immense amount of audiovisual data that is handled by content providers, often precludes the content providers from the complete assessment, evaluation, and/or manipulation, of the huge amount of digital content that is submitted to them for posting. Therefore, in many cases, audiovisual content is stored in the content provider's system despite of the fact that they are likely to be accessed (consumed) only by a relatively small number of clients or, if relatively a large number of clients do consume the content, many of them may find it obnoxious, abusive or boring. Other scenarios may exist, in which an audiovisual content selection is relatively popular (consumed by many clients) at the beginning, but later on many clients may loose interest in it. In addition, multimedia files of a duplicate nature or nearly the same content may needlessly be stored on the content provider's system.

### Audio-Visual Content and Digital Media

In digital context, the term “Audio-Visual Content” generally refers to digital media such as digital audio and digital video technologies.

Digital media (as opposed to analog media) usually refers to electronic media that work on digital codes. Today, computing is primarily based on the binary numeral system. In this case digital refers to the discrete states of “0” and “1” for representing arbitrary data. Computers are machines that (usually) interpret binary digital data as information and thus represent the predominating class of digital information processing machines. Digital media like digital audio, digital video and other digital “content” can be created, referred to and distributed through digital information processing machines. Digital media represents a profound change from previous (analog) media.

Digital data is per se independent of its interpretation (hence representation). An arbitrary sequence of digital code like “0100 0001” might be interpreted as the decimal number 65, the hexadecimal number 41 or the glyph “A”.

### Digital Audio

Audio, or sound, is a disturbance of mechanical energy that propagates through matter as a wave. Sound is characterized by the properties of sound waves, which are frequency, wavelength, period, amplitude and velocity or speed.

Audio, noise and sound often mean the same thing; when they differ, a noise is an unwanted sound. In science and engineering, noise is an undesirable component that obscures a signal.

Humans perceive sound by the sense of hearing. By sound, we commonly mean the vibrations that travel through air and can be heard by humans. However, scientists and engineers use a wider definition of sound that includes low and high frequency vibrations in air that cannot be heard by humans, and vibrations that travel through all forms of matter, gases, liquids and solids. The matter that supports the sound is called the medium. Sound propagates as waves of alternating pressure, causing local regions of compression and rarefaction. Particles in the medium are displaced by the wave and oscillate. The scientific study of sound is called acoustics.

Sound is perceived through the sense of hearing. Humans and many animals use their ears to hear sound, but loud sounds and low frequency sounds can be perceived by other parts of the body through the sense of touch. Sounds are used in several ways, most notably for communication through speech or, for example, music. Sound can also be used to acquire information about properties of the surrounding environment such as spatial characteristics and presence of other animals or objects. For example, bats use echolocation, ships and submarines use sonar, and humans can determine spatial information by the way in which they perceive sounds.

The range of frequencies that humans can hear well is between about 20 Hz and 16,000 Hz. This is by definition the hearing range, but most people can hear above 16,000 Hz provided the sound pressure level is above the hearing threshold level. At 40,000 Hz and higher frequencies, for instance, this level is about 140 dB. The hearing range varies by individual and, mostly in the upper part of the range, hearing damage accumulates with age. The ear is most sensitive to frequencies around 3,500 Hz. Sound above the hearing range is known as ultrasound, and that below the hearing range as infrasound.

The amplitude of a sound wave is specified in terms of its pressure. The human ear can detect sounds with a very wide range of amplitudes and so a logarithmic decibel amplitude scale is used. The quietest sounds that humans can hear have an amplitude of approximately 20 μPa (micropascals) or a sound pressure level (SPL) of 0 dB re 20 μPa (often incorrectly abbreviated as 0 dB SPL). Prolonged exposure to a sound pressure level exceeding 85 dB can permanently damage the ear, sometimes resulting in tinnitus and hearing impairment. Sound levels in the hearing range, in excess of 130 dB are considered more than the human ear can withstand and may result in serious pain and permanent damage. At very high amplitudes, sound waves exhibit non-linear effects including shock.

The speed at which sound travels depends on the medium through which the sound waves pass, and is often quoted as a fundamental property of the material. In general, the speed of sound is proportional to the square root of the ratio of the stiffness of the medium and its density. Those physical properties and the speed of sound change with ambient conditions. For example, the speed of sound in air and other gases depends on temperature. In air, the speed of sound is approximately 345 ms⁻¹, in water 1500 ms⁻¹ and in a bar of steel 5000 ms⁻¹.

Sound pressure is the pressure deviation from the local ambient pressure caused by a sound wave. Sound pressure can be measured using a microphone in air and a hydrophone in water. The SI unit for sound pressure is the pascal (symbol: Pa). The instantaneous sound pressure is the deviation from the local ambient pressure caused by a sound wave at a given location and given instant in time. The effective sound pressure is the root mean square of the instantaneous sound pressure over a given interval of time. In a sound wave, the complementary variable to sound pressure is the acoustic particle velocity. For small amplitudes, sound pressure and particle velocity are linearly related and their ratio is the acoustic impedance. The acoustic impedance depends on both the characteristics of the wave and the medium. The local instantaneous sound intensity is the product of the sound pressure and the acoustic partical velocity and is, therefore, a vector quantity.

Digital audio comprises audio signals stored in a digital format. Digital technology has emerged because of its supreme usefulness to sound recording, manipulation, mass-production and distribution. The modern day distribution of music across the internet through on-line stores depends on digital recording, and digital compression algorithms. “Dematerialization” of the music software into computer files has significantly reduced costs of distribution. However, it has brought about the concomitant rise in music sharing thorough peer to peer networks

From the Long-play gramophone record and compact cassette, the 78 RPM vinyl records and wax cylinders before them, analogue audio music storage and reproduction have been based on the same principles upon which human hearing are based. Sounds begin and end as mechanical energy wave forms in air, are captured in said wave form, and transformed into an electrical energy by a microphone transducer. Although its nature may change, its fundamental wave-like characteristics remain unchanged during its storage, transformation, duplication, amplification. Up until very recently, analogue audio is susceptible to significant information loss, as noise and distortions tend to creep in at each stage.

On the other hand, the digital audio chain begins when sound is converted into electrical signals—‘on/off’ pulses—rather than electro-mechanical signals. The advantage of digital audio is the ability to be copied or transmitted more conveniently, and with arguably lower loss. This ability to control signal losses is important in a professional studio environment, where signals could pass many times through cables, mixing desks and processing equipment before the recording is finally mixed down onto a two-track master for manufacturing.

Sound inherently begins and ends as an analogue signal, and in order for the benefits of digital audio to be realised, the integrity of the signal during transmission must be preserved. The conversion process at both ends of the chain must also be of low loss in order to ensure sonic fidelity.

In an audio context, the digital ideal would be to reproduce signals sounding close to the original analogue signal. In other words, the theoretical limits of the human auditory system governs the technical scheme used during the conversion process, at least as of mid 2006. However, conversion is “lossy”: conversion and compression algorithms deliberately discard the original sound information, mainly harmonics, outside the theoretical audio bandwidth. (This is discussed in the articles about CDs and MP3.)

Digital information is also lost in transfer through misreading, but can be “restored” by error correction and interpolation circuitry. Put another way, the information is only lost on the conversion from analogue to digital (and vice versa), and the amount of loss can be more predictable.

The restoration of the original music waveforms by decompression during playback should exactly mirror the compression process. However, upper harmonics which have been discarded can never be restored, with complete accuracy or otherwise. Upon its re-conversion into analogue through the amplifier/loudspeaker, the scheme relies heavily on the human brain to “fill in the gaps”—that is to say supply the missing sound during playback. This capability has been well discussed especially with respect to the brain supplying the fundamental frequency of a tone.

The generally accepted frequency response of human hearing is from 20 Hz-20 kHz. According to Nyquist, the maximum bandwidth that can be represented by a digital signal less is half that of the sample rate. This leads to a required sample rate of at least 40 kHz. In practice, a slightly higher sample rate is needed to allow for a practical anti-aliasing filter. But, the Shannon equation for reconstructing the original data fully requires infinite samples.

In the early days of digital audio, the only practical storage device with sufficient bandwidth and storage space was a video recorder and these were adapted to store the digital signal, usually by interfacing said video recorder to a PCM adaptor. Some simple mathematics shows that it is possible to use either 525/60 NTSC or 625/50 PAL video with a sampling rate of 44.1 kHz, a sample rate which persisted with the introduction of CD.

16 bit digital audio was adopted as the broadcast standard because it offers 96 decibels (dB) of dynamic range, enough to match the quality of broadcast analogue. Modern systems do not suffer as much from the earlier constraints of bandwidth and storage space; 96 kHz and 192 kHz sample rates and 24-bit samples are now common. The sample rate timing can now be quite precise.

Pulse-code Modulation (PCM) is by far the most common way of representing a digital signal. It is simple and is compressed. A PCM representation of an analogue signal is generated by measuring (sampling) the instantaneous amplitude of the analogue signal, and then quantising the result to the nearest bit. However, such rounding contributes to the loss of the original information.

Whether a sound is “good” or not is subjective—it can not be easily or objectively measured. It will depend upon the listener's preferences and hearing capabilities, the listener's and speaker placement in a given room, and the room's physical properties. The idea is to reproduce the music in such a manner that the sonic and emotional message is faithfully communicated to the listener: for example where replay of a live recording captures the sensation of being at a “live” performance.

The arguments are valid for the evaluation of any audio system and not exclusively digital systems. Whilst “controlled” listening tests are difficult, a musician who has played the song, or one who attended several symphony concerts could be a good judge. Of interest are qualities like pitch, echo, spatial origins, tone, timing, phase, excitement/pace, body, timbre, detail, dynamic range and body.

Examples of digital audio technologies:
1. Digital audio tape (DAT)
2. DAB (Digital Audio Broadcasting)
3. Compact disc (CD)
4. DVD DVD-A
5. Minidisc (obsolete as of 2005)
6. Super audio compact disc
7. Digital audio workstation
8. Digital audio player
9. and various audio file formats

Examples of digital audio interfaces:
1. AC97 (Audio Codec 1997) interface between Integrated circuits on PC motherboards
2. ADAT interface
3. AES/EBU interface with XLR connectors
4. AES47, Professional AES3 digital audio over Asynchronous Transfer Mode networks
5. I2S (Inter-IC sound) interface between Integrated circuits in consumer electronics
6. MIDI low-bandwidth interconnect for carrying instrument data; cannot carry sound
7. S/PDIF, either over coaxial cable or TOSLINK

Audio signals can also be carried losslessly over general-purpose buses such as USB or FireWire.

### Digital Video

Video is the technology of capturing, recording, processing, transmitting, and reconstructing moving pictures, typically using celluloid film, electronic signals, or digital media, primarily for viewing on television or computer monitors.

The term video (from the Latin for “I see”) commonly refers to several storage formats for moving pictures: digital video formats, including DVD, QuickTime, and MPEG-4; and analog videotapes, including VHS and Betamax. Video can be recorded and transmitted in various physical media: in celluloid film when recorded by mechanical cameras, in PAL or NTSC electric signals when recorded by video cameras, or in MPEG-4 or DV digital media when recorded by digital cameras.

Quality of video essentially depends on the capturing method and storage used Digital television (DTV) is a relatively recent format with higher quality than earlier television formats and has become a standard for television video.

3D-video, digital video in three dimensions, premiered at the end of 20th century. Six or eight cameras with realtime depth measurement are typically used to capture 3D-video streams. The format of 3D-video is fixed in MPEG-4 Part 16 Animation Framework eXtension (AFX).

In the UK, Australia, and New Zealand, the term video is often used informally to refer to both video recorders and video cassettes; the meaning is normally clear from the context.

Frame rate, the number of still pictures per unit of time of video, ranges from six or eight frames per second (fps) for old mechanical cameras to 120 or more frames per second for new professional cameras. PAL (for example, Europe, Asia and Australia) and SECAM (for example, France, Russia and parts of Africa) standards specify 25 fps, while NTSC (for example, USA, Canada and Japan) specifies 29.97 fps. Film is shot at the slower frame rate of 24 fps. To achieve the illusion of a moving image, the minimum frame rate is about ten frames per second

Video can be interlaced or progressive. Interlacing was invented as a way to achieve good visual quality within the limitations of a narrow bandwidth. The horizontal scan lines of each interlaced frame are numbered consecutively and partitioned into two fields: the odd field consisting of the odd-numbered lines and the even field consisting of the even-numbered lines. NTSC, PAL and SECAM are interlaced formats. Abbreviated video resolution specifications often include an i to indicate interlacing. For example, PAL video format is often specified as 576i50, where 576 indicates the vertical line resolution, i indicates interlacing, and 50 indicates 50 fields (half-frames) per second.

In progressive scan systems, each refresh period updates all of the scan lines. The result is a higher perceived resolution and a lack of various artifacts that can make parts of a stationary picture appear to be moving or flashing.

A procedure known as deinterlacing can be used for converting an interlaced stream, such as analog, DVD, or satellite, to be processed by progressive scan devices, such as TFT TV-sets, projectors, and plasma panels. Deinterlacing cannot, however, produce a video quality that is equivalent to true progressive scan source material.

The size of a video image is measured in pixels for digital video or horizontal scan lines for analog video. Standard-definition television (SDTV) is specified as 720/704/640×480i60 for NTSC and 768/720×576i50 for PAL or SECAM resolution. New high-definition televisions (HDTV) are capable of resolutions up to 1920×1080p60, in other words 1920 pixels per scan line by 1080 scan lines, progressive, at 60 frames per second.

Video resolution for 3D-video is measured in voxels (volume picture element, representing a value in three dimensional space). For example 512×512×512 voxels resolution, now used for simple 3D-video, can be displayed even on some PDAs.

Aspect ratio describes the dimensions of video screens and video picture elements. The screen aspect ratio of a traditional television screen is 4:3, or 1.33:1. High definition televisions use an aspect ratio of 16:9, or about 1.78:1. The aspect ratio of a full 35 mm film frame with soundtrack (also known as “Academy standard”) is around 1.37:1.

Pixels on computer monitors are usually square, but pixels used in digital video have nonsquare aspect ratios, such as those used in the PAL and NTSC variants of the CCIR 601 digital video standard, and the corresponding anamorphic widescreen formats.

Color model name describes the video color representation. YIQ is used in NTSC television. It corresponds closely to the YUV scheme used in PAL television and the YDbDr scheme used by SECAM television.

The number of distinct colors that can be represented by a pixel depends on the number of bits per pixel (bpp). A common way to reduce the number of bits per pixel in digital video is by chroma subsampling (for example 4:4:4, 4:2:2, 4:2:0).

Video quality can be measured with formal metrics like PSNR or with subjective video quality using expert observation.

The subjective video quality of a video processing system may be evaluated as follows:
1. Choose the video sequences (the SRC) to use for testing.
2. Choose the settings of the system to evaluate (the HRC).
3. Choose a test method for how to present video sequences to experts and to collect their ratings
4. Invite a sufficient number of experts, preferably not fewer than 15.
5. Carry out testing.
6. Calculate the average marks for each HRC based on the experts' ratings.

Many subjective video quality methods are described in the ITU-T recommendation BT.500. One of the standardized method is the Double Stimulus Impairment Scale (DSIS). In DSIS, each expert views an unimpaired reference video followed by an impaired version of the same video. The expert then rates the impaired video using a scale ranging from “impairments are imperceptible” to “impairments are very annoying”.

A wide variety of methods are used to compress digital video streams. Video data contains spatial and temporal redundancy, making uncompressed video streams extremely inefficient. Broadly speaking, spatial redundancy is reduced by registering differences between parts of a single frame; this task is known as intraframe compression and is closely related to image compression. Likewise, temporal redundancy can be reduced by registering differences between frames; this task is known as interframe compression, including motion compensation and other techniques. The most common modern standards are MPEG-2, used for DVD and satellite television, and MPEG-4, used for home video.

A video codec is a device or software module that enables video compression or decompression for digital video. The compression usually employs lossy data compression. Historically, video was stored as an analog signal on magnetic tape. Around the time when the compact disc entered the market as a digital-format replacement for analog audio, it became feasible to also begin storing and using video in digital form, and a variety of such technologies began to emerge.

Audio and video call for customized methods of compression. Engineers and mathematicians have tried a number of solutions for tackling this problem.

There is a complex balance between the video quality, the quantity of the data needed to represent it (also known as the bit rate), the complexity of the encoding and decoding algorithms, robustness to data losses and errors, ease of editing, random access, the state of the art of compression algorithm design, end-to-end delay, and a number of other factors.

### Rating, Assessing and Filtering Content Distributed Over Data Networks

Collaborative filtering (CF) is the method of making automatic predictions (filtering) about the interests of a user by collecting taste information from many users (collaborating). The underlying assumption of CF approach is that: Those who agreed in the past tend to agree again in the future. For example, a collaborative filtering or recommendation system for music tastes could make predictions about which music a user should like given a partial list of that user's tastes (likes or dislikes). These predictions are specific to the user, but use information gleaned from many users. This differs from the more simple approach of giving an average (non-specific) score for each item of interest, for example based on its number of votes.

Collaborative filtering systems usually take two steps:
1. Look for users who share the same rating patterns with the active user (the user who the prediction is for).
2. Use the ratings from those like-minded users found in step 1 to calculate a prediction for the active user

Another form of collaborative filtering can be based on implicit observations of normal user behavior (as opposed to the artificial behavior imposed by a rating task). In these systems you observe what a user has done together with what all users have done (what music they have listened to, what items they have bought) and use that data to predict the users behavior in the future or to predict how a user might like to behave if only they were given a chance. These predictions then have to be filtered through business logic to determine how these predictions might affect what a business system ought to do. It is, for instance, not useful to offer to sell somebody some music if they already have demonstrated that they own that music.

In the age of information explosion such techniques can prove very useful as the number of items in only one category (such as music, movies, books, news, web pages) have become so large that a single person cannot possibly view them all in order to select relevant ones. Relying on a scoring or rating system which is averaged across all users ignores specific demands of a user, and is particularly poor in tasks where there is large variation in interest, for example in the recommendation of music. Obviously, other methods to combat information explosion exist such as web search, clustering, and more.

More recently, collaborative filtering has been used in e-learning to promote and benefit from students' collaboration.

Collaborative filtering stems from the earlier system of information filtering, where relevant information is brought to the attention of the user by observing patterns in previous behavior and building a user profile. This system was essentially unable to help with exploration of the web and suffered from the cold-start problem that new users had to build up tendencies before the filtering was effective.

The first system to use collaborative filtering was the Information Tapestry project at Xerox PARC. This system allowed users to find documents based on previous comments by other users. There were many problems with this system as it only worked for small groups of people and had to be accessed through word specific queries which largely defeated the purpose of collaborative filtering.

USENET Net news furthered collaborative filtering such that it was available for a mass scale of users while having a simpler method for accessing articles. The system allowed users to rate material based on popularity, which then allowed other users to search for articles based on these ratings.

Active filtering is a method that in recent years has become more and more popular. This popularity increase is due to the fact that there is an ever growing base of information available to users of the World Wide Web. With an exponentially growing amount of information being added to the internet, finding efficient and valuable information is becoming more difficult. In recent years a basic search for information using the World Wide Web turns out thousands of results and a high percentage of this information is not effective and—more often than not—irrelevant as well. There are a large amount of databases and search engines in the market today to use for searches but a majority of the population is not familiar with all the options available and this is where Active filtering comes into effect.

Active Filtering differs from other methods of collaborative filtering due to the fact that it uses a peer to peer approach. This means that it is a system where peers, coworkers, and people with similar interests rate products, reports, and other material objects and share this information over the web for other people to see. It is a system based on the fact that people want to share consumer information with the other peers. The users of Active filtering use lists of commonly used links to send the information over the World Wide Web where others can view it and use the ratings of the products to make their own decisions.

Active collaborative filtering can be useful to many people in many situations. This type of filtering can be extremely important and effective in a situation where a non-guided search such as [Yahoo.com] produces thousands of results that are not useful or effective for the person locating the information. In cases where people are not comfortable of knowledgeable with the array of databases that are available to them, Active filtering is very useful and effective.

Advantages: There are many advantages to using or viewing an Active collaborative filtering. One of these advantages is an actual rating given to something of interest by a person who has viewed the topic or product of interest. This produces a reasonable explanation and rank from a reliable source, being the person who has come into contact with the product. Another advantage of Active filtering is the fact that the people want to and ultimately do provide information regarding the matter at hand.

Disadvantages: There are a few disadvantages regarding Active filtering. One is that the opinion maybe bias to the matter. Another disadvantage is the fact that it is a very complex system and that many people may not support or add necessary information to the topic.

A method of collaborative filtering that is thought to have great potential in the future is passive filtering, which collects information implicitly. A web browser is used to record a user's preferences by following and measuring their actions. These implicit filters are then used to determine what else the user will like and recommend potential items of interest. Implicit filtering relies on the actions of users to determine a value rating for specific content, such as purchasing an item, repeatedly using, saving, printing an item, refer or link to a site, number of times queried.

An important feature of passive collaborative filtering is using the time aspect to determine whether a user is scanning a document or fully reading the material. The greatest strength of the system is that it takes away certain variables from the analysis that would normally be present in active filtering. For example, only certain types of people will take the time to rate a site, in passive collaborative filtering anyone accessing the site has automatically given data.

Item based filtering is another method of collaborative filtering in which items are rated and used as parameters instead of users. This type of filtering uses the ratings to group various items together in groups so consumers can compare them as well as a rating scale that is available to manufacturers so they can locate where their product stands in the market in a consumer based rating scale.

Through this method of filtering, users or user groups use and test the product and give it a rating that is relevant to the product and the product class in which it falls. These users test many products and with the results, the products are classified based on the information which the rating holds. The products are used and tested by the same user or group in order to get an accurate rating and eliminate some of the error that is possible in the tests that take place under this type of filtering.

Within active and passive filtering there are explicit and implicit methods for determining user preferences. Explicit collection of user preferences relies on the evaluator user determining a value for the content based on some form of rating scale. This creates a cognitive aspect to collaborative filtering. Implicit collection does not involve the direct input of opinion from the evaluator user, but rather they input their opinion through their actions while on the website. This reduces the demand on the user and is reduces variables amongst users.

### Methods for Controlling Audio-Visual Content Distributed Over Data Networks

One way to control audiovisual content that is distributed (posted) over data networks is by legislation. The legislation may be initiated by governmental bodies, or by private or industry standards organizations. However, using legislation may prove inefficient because there is no global legislation harmonization as far as Internet content is concerned. In addition, human rights organizations worldwide usually condemn such censorship legislation attempts as abusing or limiting the freedom of speech and expression. For this reason (and for other reasons which are not specified herein), users of the Internet (for example) freely publicize uncensored content items that may prove to be unpopular.

Another way to control audiovisual content that is distributed over data networks, such as the Internet, may involve employing an automatic ranking mechanism for audiovisual content selection. Such a mechanism may work in such a way that digital content will be judged by the viewers themselves, or at least by a predetermined control group that consists of reviewers, as opposed to it being censored by a governmental or non-governmental authority. Viewers will tend to discard unpopular, abusive or boring digital content. Discarding digital content will free memory space in the related content provider's system. However, such an automatic mechanism for audiovisual content selection does not seem to exist.

### Glossary

“Digital content” (“content”, for short) generally refers herein to audiovisual like content files, each audiovisual content file may be a digital media file that may include, for example, picture(s), video streams, audio/music content, audiovisual content, text, and so on. Content may be stored and managed by one administrator, though it can be stored in different storage arrays or in a common storage array. Content may be forwarded by many users from their own personal computers (PCs) to the storage array(s), over a data network, in order for the content to be publicized to other users through the data network. “Content Item” generally refers to a single content file, for example a single video clip, a piece of music, a group of PowerPoint pictures, and so on.

“problematic item” is a single content file that has some kind of problem with one or more of its components.

For example:
1. An item contains a short film which is very interesting as for it self, but has a title which contains vulgar language that is not appropriate for distributing through the net.
2. An item contains a film which is 2 minutes long, and is very interesting in its first minute, while its second minute is boring.

“Client” generally refers herein to a person forwarding digital content to (for the consumption of other clients) and/or consuming digital content from a content provider through a data network. Depending on the context, client may also refer to the computer used by a user to forward digital content to and/or consuming digital content from a content provider through a data network.

“Reviewers” generally refers herein to a group of clients or users functioning as a test, censors, or critic group (generally called herein a “control group”). Some clients may be asked to become reviewer(s) on a voluntary basis, and some other clients may be picked up automatically without them knowing of their selection as reviewers. A reviewer is intended to judge (vote for) a new content item (such as by ranking the content item in one or more categories) that has not been yet publicized, before a decision is reached whether the new content item is eligible and, therefore, can be consumed by clients that are not necessarily reviewers. A reviewer is a potential voter and s/he is a voter if s/he submits his/her a voting value for a content item. The group of reviewers may be as large as required or desired Depending on a system manager's decision or on the process requirements, new items may be sent only to a pre-selected subgroup of reviewers or to the entire reviewers group. User(s) can be reviewer(s) and, at the same time, maintain regular users characteristics; that is, in addition to getting content item(s) for their own use (for entertainment or education purposes, for example), user(s) may get new content items which they will be asked to rank. Any new content item needed to be ranked will be sent to reviewer(s) with an appropriate message (for example ‘ranking needed’) that will prompt the reviewer(s) to rank the new content item.

“Voting value” is a value generated by a reviewer for reflecting his/her impression of a new content item in one or more aspects or categories. For example, assuming that a given content item is to be reviewed in respect to the exemplary categories of “violence”, “pornography”, “amusing”, “interesting”, “thrilling”, a reviewer may generate a voting value associated with the given content item by ranking the content item in one or more of the categories, and aggregating the rankings to obtain the voting value. A “Voter” is a reviewer submitting a voting value for a given content item.

“Min. ranks for distribution” (or “Min. ranks”, for short) is a ranking threshold value that reflects herein a wanted, or preferred, minimal number of reviewers that reviewed the content item involved (by ranking it in one or more categories). The Min. ranks threshold value is predetermined in order to ensure that a content item gets reviewed by a sufficiently large number of reviewers, which is the minimal number of reviewers that will render the content items sorting process realistic. Of course, the greater the number of the reviewers ranking a content item, the more realistic the result of the sorting process will become.

“Min. avg. rank for distribution” (or “Min. avg. rank”, for short) is a threshold value that generally refers herein to a minimum average rank (in points) needed to decide whether a given content item is an eligible item (that is, the content item's quality is sufficiently high), which renders the content item suitable for distribution. For example, on a scale of 1-5 points, 3 points may be predetermined as the Min avg. rank and any content item that has been ranked (on the average) 3 or more points may be considered an eligible content item
“Max. Number of exceptional votes” (or “Max. exceptions”) is a threshold value that generally refers herein to the maximum allowable number of exceptional, extreme, illogical, uncommon, unexpected or irrational rankings (herein referred to collectively as “deviant vote”) submitted by a given reviewer (herein referred to collectively as a “deviant voter”), for which a voted content item will still be considered a content item that is eligible for distribution/posting. The terms ‘distribution’ and ‘posting’ both refer to sending (on demand) content item(s) from content provider(s) (or from an inter-mediator site associated with, or which provides a sorting service to the content provider(s)) to content item(s) consumers (clients). The terms ‘distribution’ and ‘posting’ are herein used interchangeably. It can be decided, for example, that the occurrence of one deviant vote, for example in the “violence” category (that is, a single reviewer said that a content item is too, or very, violent), may suffice to disqualify that item, in which case the disqualified content item will not be distributed (that is, unless the deviant vote, or deviant voter/reviewer will be reassessed after assigning to it/him/her a weight lower than the maximal weight of 1.0, which is a default, or initial, weight).

“Distribution policy” generally is an aggregation of distribution rules, where a distribution rule may be defined by a threshold value such as Min. ranks and/or Min. avg. rank and/or Max. exceptions, and/or any other criteria and/or any combination consisting of any of the specified threshold value(s) and other criterion and/or threshold value.

“Thumbnails” are graphical representations or pictures of an idea, concept, or content they represent. Thumbnails are generally square in size, and are about the size of a person's thumb nail, hence the name. An example of a thumbnail would be a picture of a ballplayer to represent some sort of sports content.

### SUMMARY

The following embodiments and aspects thereof are described and illustrated in conjunction with systems, tools and methods, which are meant to be exemplary and illustrative, not limiting in scope. In various embodiments, one or more of the above-described problems have been reduced or eliminated, while other embodiments are directed to other advantages or improvements.

As part of the present disclosure a method, conducted through an automatic process, of selecting content items for on-line posting is provided. In addition a post review process is also provided for content that has already been posted, since digital content needs to be, and can be improved all the time, according to the users' opinion, before and\or after it has been distributed to the public.

In some embodiments, there is provided herein a method of post review of content items previously posted on a shared network resource, the method may include receiving a suggestion from a viewer with respect to a proposed change to a previously posted content item and submitting the suggestion to a control group for a ratification vote of the proposed change to the previously posted content item.

There is also provided, according to some embodiments, a system for post review of content items previously posted on a shared network resource, may include a media content sorter adapted to receive from one or more voters voting values for a proposed change in a previously posted content item and to replace a changed content item with the a previously posted content item if the voting values comply with a predefined policy.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in the referenced figures. It is intended that the embodiments and figures disclosed herein are to be considered illustrative, rather than restrictive. The disclosure, however, both as to organization and method of operation, together with objects, features, and advantages thereof, may best be understood by reference to the following detailed description when read with the accompanying figures, in which:

FIG. 1 schematically illustrates an exemplary general system for automating the control and sorting of content item(s) according to an embodiment of the present disclosure;

FIG. 2 is an exemplary flowchart for automatically controlling and sorting content items in accordance with an embodiment of the present disclosure; and

FIG. 3 is an exemplary flowchart for automatically post review of content items previously posted on a shared network resource in accordance with an embodiment of the present disclosure.

It will be appreciated that for simplicity and clarity of illustration, elements shown in the figures have not necessarily been drawn to scale. For example, the dimensions of some of the elements may be exaggerated relative to other elements for clarity. Also, at times singular or plural (or options between singular and plural) may be described, however, notations or descriptions of singular include, or is to be construed as, plural, and plural include, or is to be construed as singular where possible or appropriate.

### DETAILED DESCRIPTION

In the following detailed description, numerous specific details are set forth in order to provide a thorough understanding of the disclosure. However, it will be understood by those skilled in the art that the present disclosure may be practiced without these specific details. In other instances, well-known methods, procedures, components and circuits have not been described in detail so as not to obscure the present disclosure.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present disclosure may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present disclosure are not described with reference to any particular programming language. It will be appreciated that a variety of programming languages may be used to implement the teachings of the disclosures as described herein.

In some embodiments, there is provided herein a method of post review of content items previously posted on a shared network resource, the method may include receiving a suggestion from a viewer with respect to a proposed change to a previously posted content item and submitting the suggestion to a control group for a ratification vote of the proposed change to the previously posted content item.

The suggestion may include a change in the title of the previously posted content item. The suggestion may include a change in the length of the previously posted content item. The change in the length of the previously posted content item may be performed, for example, by defining new start an finish points for the previously posted content item. The suggestion may include a change in the thumbnail that represents the previously posted content item. The suggestion may be submitted by the viewer through an online form. The suggestion and the previously posted content item are sent to the control group, and wherein the control group is requested to view the previously posted content item and the suggestion and are asked to choose by the ratification vote which version they prefer.

The verification vote may require a minimum number of votes to ensure an accurate representation of public opinion. The verification vote may require a simple majority to make a change in the previously posted content item. The verification vote may require a predefined majority to make a change in the previously posted content item.

A voter may be a part of a control group consisting of reviewers. The reviewers may include pre-selected clients. The reviewers may include clients volunteering to serve as reviewers.

There is also provided, according to some embodiments, a system for post review of content items previously posted on a shared network resource, may include a media content sorter adapted to receive from one or more voters voting values for a proposed change in a previously posted content item and to replace a changed content item with the a previously posted content item if the voting values comply with a predefined policy.

The proposed change may include a change in the title of the previously posted content item. The proposed change may include a change in the length of the previously posted content item. The change in the length of the previously posted content item may be produced by defining new start an finish points for the previously posted content item. The proposed change may comprises a change in the thumbnail that represents the previously posted content item. The proposed change may be submitted by the viewer through an online form. The proposed change and the previously posted content item are sent to the control group, and wherein the control group is requested to view the previously posted content item and the proposed change and are asked to choose by the ratification vote which version they prefer. The verification vote may require a minimum number of votes to ensure an accurate representation of public opinion. The voting values may require a majority voting for a changed content item to make a change in the previously posted content item. The voting values may require a predefined majority to make a change in the previously posted content item. The voter may be a part of a control group consisting of reviewers. The reviewers may include pre-selected clients. The reviewers may include clients volunteering to serve as reviewers.

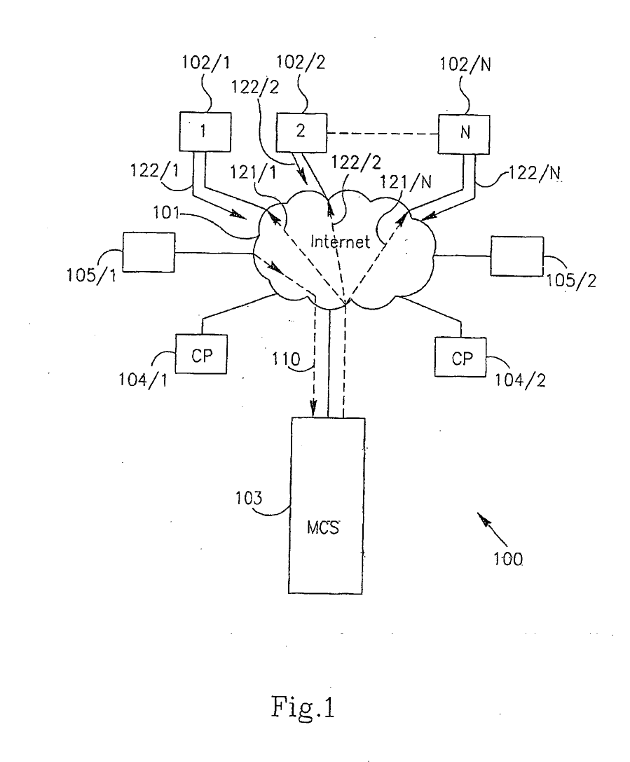

Referring now to FIG. 1, a general system (shown at 100) for automating the control and sorting of digital media content is shown and described according to an embodiment of the present disclosure. Clients 102/1 to 102/N, Media Content Sorter (MCS) 103, Content Providers (CPs) 104/1 and 104/2 are shown connected to Internet 101. Clients 102/1 to 102/N are reviewers participating in the voting process. Reviewers 102/1 to 102/N, which form an exemplary control group, may be either pre-selected by MCS 103 for voting purposes, or they may volunteer to serve as reviewer(s), usually after being prompted to do so by MCS 103. For example, client 102/1 may be pie-selected by MCS 103 as a reviewer, and clients 102/2 through 102/N may serve as reviewers on a voluntary basis. A client pre-selected by MCS 103 as a reviewer may not be aware of his selection (by MCS 103) as a reviewer. Clients 105/1 to 105/2 are ordinary clients (they do not serve as reviewers), which means that they have not been selected by MCS 103 as reviewer(s) (for voting purposes), nor did they volunteer to serve as reviewer(s).

Regardless of whether a client is a reviewer or an ordinary client, each client may forward a content item to MCS 103 with the intention that other clients access that content item. For example, dotted line 110 denotes forwarding a content item from client 105/1 (an ordinary client in this example). Upon receiving a content item from any client, MCS 103 has to reach a decision (a distribution/discard decision) whether the content item forwarded to MCS 103 is an eligible content item (and therefore suitable for distribution to clients of Internet 101) or not, in which case the content item will not be distributed to any client which is not a reviewer. In order to facilitate the making of that decision, MCS 103 may forward, or distribute, the content item to the pre-selected and/or volunteering reviewers 102/1 through 102/N (shown at 121/1 through 121/N, respectively).

Each one of reviewers 102/1 through 102/N may (or may not) independently make his/her own vote, by ranking the content item in one or more categories according to his/her impression of the involved content item, and, thereafter, forward (shown at 122/1 through 122/N) a voting value corresponding to his/her ranking. Although each one of reviewers 102/1 through 102/N is shown (at 122/1 through 122/N) forwarding a voting value, it may occasionally occur that the number of reviewers actually voting on (sending their impressions in respect of) a given content item is less than N. For example, among 10,000 potential (pre-selected and/or volunteers) reviewers (N=10,000) only 2,500 reviewers may actually participate in a voting process associated with a given content item.

Different methodologies may be applied to get a reviewer's impression. For example, a review form may be used. The review form may contain a series of questions related to the content to be reviewed. The questions may consist of yes/no/don't' care answers and/or present the reviewer with a ranking scale. A specific weighting can be applied to each of the questions depending on an importance/priority decided upon by the MCS 103. An example of a ranking scale would be a scale ranging from a five (5) (strongly approve/enjoy) to a one (1) (strongly disagree/dislike) After receiving voting values from reviewers, MCS 103 may mitigate a weight of voting value(s) associated with deviant voter(s) and post content item(s) whose weighted value is above a threshold value. Known methods of rating/ranking content as well as known methods of statistical processing can be employed for determining deviant voting values (outliers), and will not be discussed further.

Although it is assumed that the control group (or a sub-group thereof) generally represents the public majority's preferences as to publicized content items, it may sometimes occur that some voters have subjective views, which may have unwanted implications on the voted content item and, therefore, on other clients. For example, a video clip (an exemplary content item) may include a violent scene which may generally be thought of as having an acceptable level of violence, but some reviewers may think that even scene(s) that include(s) the slightest, or even an implied, violence should not be distributed (should not be publicized or rendered accessible) to clients at all. Deviant voters contribute undesired or unwanted contribution to the decision making process. A reviewer is recognized as a deviant voter, for example if one of his/her currently submitted rankings in a given category is an outlier from what is commonly accepted as streamline ranking. In order to minimize the effect of deviant votes on the final voting result, and therefore on the ensuing distribution or non-distribution final decision, each one of the voters may be characterized, for example by MCS 103 of FIG. 1, to maintain a generally more balanced control group that will represent the public's preferences in a more realistic manner.

Characterization of reviewers preferences or tendencies is refereed to as their karma, and may involve, among other things, automatically performing through the MCS 130 several actions, among which is generation of a personal reviewer file for each reviewer. The generation of the personal reviewer file is carried out in the background without the knowledge of the reviewer. A personal reviewer file may contain a reviewer's unique characteristics (karma), and also their past and/or current voting value(s) compared to voting value(s) characterizing, what may be thought of as, mainstream preferences. A reviewer's unique characteristics as defined by the MCS 103 may include perceived or stated attitudes in relation to sex, money, religion, politics, or other taboo subjects A personal reviewer file may be dynamically and automatically modified to minimize the relative effect a deviant reviewer may have on different aspects of the voting process and/or on the final voting result.

For example a reviewer, who is averse to consuming any sort of pornographic content items, may get a new content item for review, which is a short video clip that includes relatively mild or soft pornographic material that is generally known to be popular and is accepted as a mainstream form of entertainment. Being averse to consuming any kind of perceived pornographic content, the reviewer will likely categorize the content item as hard pornographic material, with the intention that the content item will not be publicized or rendered accessible to the non-reviewer clients. However, according to the present disclosure since this (deviant) reviewer, and maybe a few more like (deviant) reviewers, is/are a negligible minority (that is, most of the reviewers ranked the video clip as soft porno), the reviewer may be marked by the MCS 103 as a deviant voter whose voting (his voting value) makes an exception in that particularly category (in this example in the “pornographic category”). According to one embodiment of the present disclosure after being marked by the media content sorter as a deviant voter, the media content sorter may ignore future voting value(s) in that category, which will originate from the deviant voter. According to another embodiment of the present disclosure deviant ranking(s) (in one or more categories) of a deviant reviewer may be factored in after assigning to the deviant ranking(s) a lower weight. Further, if a deviant reviewer continues to submit a deviant ranking in respect of a given category, the deviant ranking may be assigned a lower weight. For example, if a weight assigned to a deviant ranking in the “violence” category is, say 0.95, and the same deviant reviewer submits (for a different content item) another deviant ranking in the same category (“violence”), his deviant ranking will be assigned a lower weight, say 0.75, and so on. Alternatively, if the next ranking of a currently considered deviant reviewer is relatively close to what is considered to be a mainstream judgment (in the involved category), his ranking, in the involved category, will be assigned a higher weight. Weights assigned to rankings of a reviewer may, therefore, be changed dynamically, as the reviewer submits more and more rankings.

After being reviewed by a sufficient number (as defined by the system's managers) of reviewers, the media content sorter may execute an evaluation process for evaluating voting values forwarded to it in order to determine whether the voted content item can be distributed/posted (rendered accessible) to clients or not. Assuming that criteria predefined by the system administrator(s) have been met, an original or modified version of the multimedia content item may be distributed to clients.

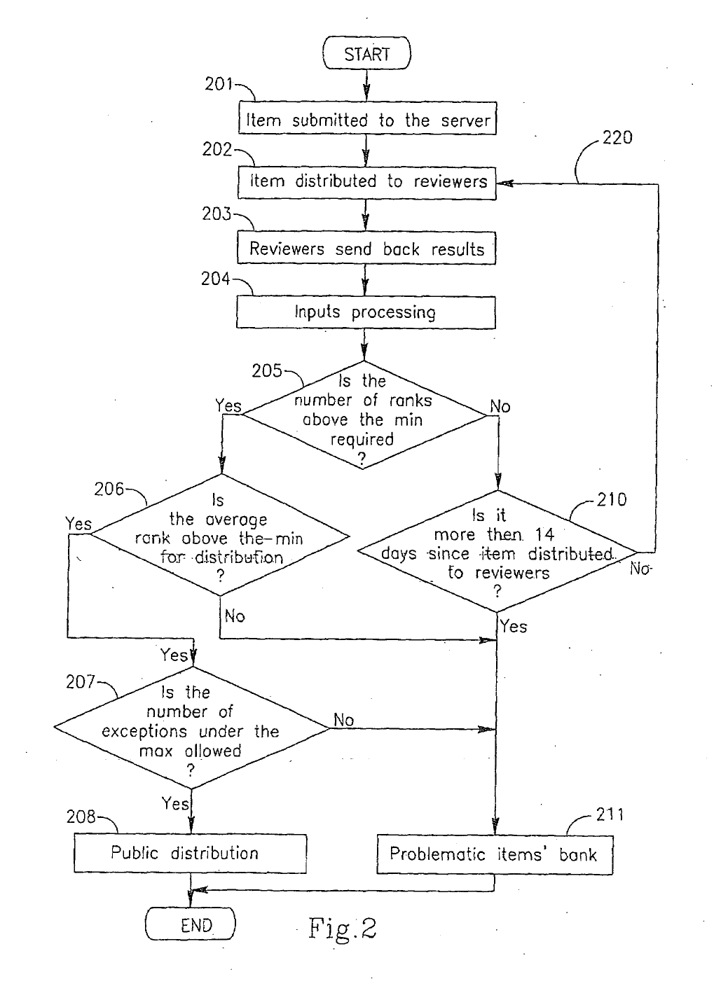

Referring now to FIG. 2, an exemplary flowchart for automatically controlling and sorting digital multimedia content is shown and described according to an embodiment of the present disclosure. The exemplary flowchart of FIG. 2 is described in association with FIG. 1. At step 201, a content item is forwarded from a client (for example from client 105/1) to a server such as MCS 103. At step 201 the forwarded content item is distributed to reviewers such as reviewers 102/1 through 102/N. At step 203, reviewers (for example 102/1 to 102/100, 100<N) forward their voting value(s), or ranking result(s). At step 204, the server (MCS 103) may process the received voting values (the voting results or ranks) and, at step 205, if the number of actual ranks submitted by reviewers is greater (shown as ‘Yes’ at 205) than a Min. ranks threshold value, then it is checked, at step 206, as to whether the actual average rank is greater than the Min. avg. rank threshold value. If the actual average rank is greater than the Min. avg. rank threshold value for distribution (shown as ‘Yes’ at 206) then, at step 207, it is checked whether the number of actual exceptions (deviant voting values) is less than the Max. exceptions threshold value. If (at step 207) the number of actual exceptions is less (shown as ‘Yes’ at 207) than the Max. exceptions threshold value, then the media content sorter may publicize (distribute to clients) the voted content item (shown at 7step 208).

If the actual number of ranks is less (shown as ‘No’ at 205) than the Min. ranks threshold value and more than a specified number of days (for example 14 days) elapsed (shown as ‘Yes’ at 210) from the first day on which the content item was distributed to reviewers, then the media content sorter may discard the content item or temporarily store it in a problematic items bank (shown at 211), optionally for further statistical evaluations (for example). If, however, less (for example 3 days) than the specified number of days (for example 14 days) elapsed (shown as ‘No’ at 210) from the first day on which the content item was first distributed to reviewers, then the media content sorter may redistribute (shown at 220) the content item to reviewers (shown at step 202), which may be the same reviewers or other reviewers. The other reviewers may be selected from the already existing control group (the control group originally defined by the media content sorter), and/or they may be clients newly added (by the media content sorter), as additional reviewers, to an existing control group, in which case it may be the that the control group is enlarged. Redistribution loop 220 may continue until the actual number of ranks is greater (shown as ‘Yes’ at 205) than the Min. ranks threshold value, or more than a specified number of days (for example 14 days) elapsed (shown as ‘Yes’ at 210) from the first day on which the content item was initially distributed to reviewers, whichever condition is met first.

If, however, the number of ranks is greater (shown as ‘Yes’ at 205) than the Min. ranks threshold value, but the number of exceptions (deviant voting values) is greater than, or equal to, the Max. exceptions threshold value, then the media content sorter may discard the content item or temporarily store it in a problematic items' bank (shown at 211), for further evaluation.

FIG. 2 demonstrates ranking of a content item as a whole. However, it is to be understood that rankings may be submitted by reviewer(s) per predetermined category, and each category associated with the content item being voted may be judged on individual basis, including counting the number of rankings submitted, counting the number of exceptions (deviating rankings in the involved category) and calculating ranking average for the involved category. Rankings submitted by reviewers, which may be associated with one or more categories, may be processed at step 204 of FIG. 2, and steps 205 and/or 206 and/or 207 and/or 210 may applied to each one of the one or more categories involved. According to an embodiment in order for a content item to be rendered accessible to clients, all ranked categories have to comply with the distribution criteria described herein.

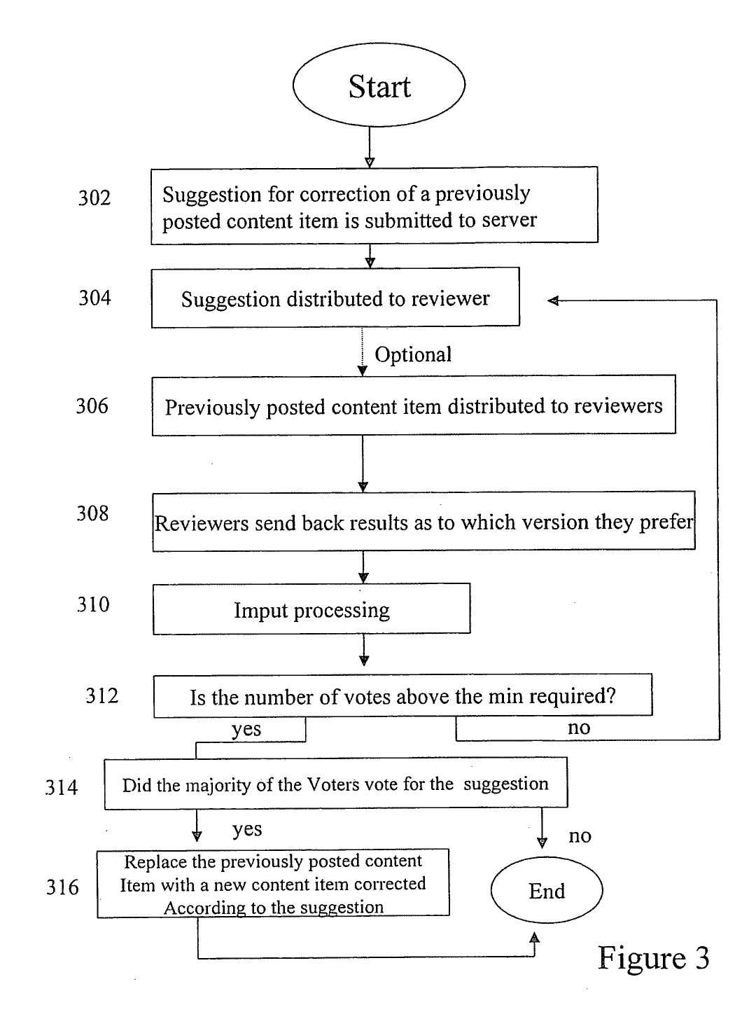

Referring now to FIG. 3, an exemplary flowchart for automatically post review of content items previously posted on a shared network resource in accordance with an embodiment of the present disclosure. The exemplary flowchart of FIG. 3 may be described in association with FIGS. 1 and/or 2. At step 302, a suggestion for improving a previously posted content item is forwarded from a client (for example from client 105/1) to a server such as MCS 103. At step 304 the suggestion for improving a previously posted content item is distributed to reviewers such as reviewers 102/1 through 102/N. At the optional step 306, the previously posted content item of reverence may or may not be distributed to reviewers such as reviewers 102/1 through 102/N. At step 308, reviewers (for example 102/1 to 102/100, 100<N) forward their voting value(s), or ranking result(s) as to which version they prefer (the previously posted content item or the corrected previously posted content item). At step 310, the server (MCS 103) may process the received voting values (the voting results or ranks) and, at step 312, if the number of actual votes submitted by reviewers is greater (shown as ‘Yes’ at 312) than a Min. threshold value, then it is checked, at step 314, as to whether the majority of the voters voted for the suggestion of correction the previously posted content item (in other words, preferred the corrected version of the previously posted content item). If the majority of the voters voted for the suggestion of correction the previously posted content (shown as ‘Yes’ at 314) then, at step 316 the corrected version of the previously posted content item is posted to replace the previously posted corresponding content item. If (at step 314) the majority of the voters voted for the previously posted content (shown as ‘No’ at 314) then, the previously posted content is maintained and not replaced.

FIG. 3 demonstrates a post review process of a content item. This process may be performed in addition to or separate from the ranking process described in FIG. 2.

An example of the multimedia content evaluation and posting process is as follows. A company X, a content publisher or provider over the Internet, has 10 million clients that submit between 10,000 and 20,000 new multimedia content items each day to its portal. In its portal, company X publishes a banner that encourages clients to act as reviewers. Each client serving as a reviewer will receive from company X new content items for review, which have not been made available for general distribution (publicized). A reviewer may continue to freely consume already publicized content items from company X and/or from other content providers. In accordance with this example, 10,000 clients positively responded and now they serve as reviewers. It is assumed that company X has defined a distribution policy which includes the following four exemplary distribution rules:
1 New multimedia content item(s) must be reviewed by at least 500 reviewers (Min. ranks for distribution=500).
2 In order for a content item to be distributed to the public (publicized), the content item has to get an average rank of at least 3 points out of 5 (in this example Min. avg. rank for distribution=3).
3. If the content item gets 2 or more rejections (in this example Max. exceptions=2) in any of the categories “certain images”, “certain implications”, “violence” or “pornography”, the content item will be disqualified and not be publicized/posted.
4. If the content item does not get enough impressions (500 in this case) from reviewers and 14 days (for example) elapsed from the day the content item was first forwarded to the reviewers, the item will not be publicized. ‘Not get enough impressions from reviewers’ means that even though the content item was forwarded to a sufficiently large number of reviewers (the content item was forwarded to a number of reviewers larger than Min. ranks), many of them were not interested in ranking the content item, regardless of their reasons.

For the sake of the example a client A submits a content item with the intention that the content item be publicized and consumed by other interested clients. The content item is distributed only to 700 reviewers with a message, for example in the form of an icon, attached to, or associated with, the content item, which says that this content item is a new content item awaiting review. Five days later, the minimum required 500 impressions (respectively originating from 500 clients) are recorded at the media content sorter, with the following results:
5. The calculated average rank was 3.2 (Avg. rank=3.2), which is greater than the predetermined threshold value (Min. avg. rank=3.0, see distribution rule 2).
6. One rejection has been recorded in the “violence” category, which according to distribution rule 3, is one rejection less than the maximum allowed number (Max. exceptions=2), whereas the other 499 reviewers found this content item eligible in all of the exemplary categories specified by exemplary distribution rule 3 described earlier.

According to this Example, the content item may be distributed (publicized) and the reviewer who rejected the content item (for being too violent in his opinion) will be marked by the media content sorter as a deviant reviewer. Thus in the future, when that reviewer will refer (in his review(s) of future content item(s)) to the “violence” aspect of item(s), his violence-wise rankings will be assigned a lower weight, so as to reduce their effect on the final decision. Reviewers rankings may be initially assigned the maximal weight of 1.0, and a ranking (in any of the categories involved) of a deviant reviewer will be assigned a lower weight, for example 0.85. In general, the more deviant is a user relative to a mainstream ranking in a given category, the lower the weight assigned to his ranking would be in the given category.

If in the previous example only 450 reviewers responded within the 14 day period, by forwarding their impressions (voting values) to the media content sorter, two solutions are possible (as is implied by FIG. 2): (1) The content item will not be publicized, or (2) The content item will be resent to reviewers and/or it will be forwarded to other or additional reviewers in order to meet the ‘Min. ranks’ criteria. This process can iterate several times, until the content item gets enough ranks or two weeks elapsed. Whichever approach will be adopted depends on the definitions set by the content provider (in this example company X). An additional aspect of the present disclosure is a post review process for content that has already been posted, since digital content needs to be, and can be improved all the time, according to the users' opinion even after it has been distributed to the public. Post review allows for automatic processing (with the MCS) of users opinions and different suggestions for posted available multimedia content. For example posted content that is a “problematic item”, that is there is some sort problem with the content is a candidate for the post review process. A problematic item could be a short film with a title that has vulgar language which limits its appeal to the general audience, but whose content is actually suitable for this audience. Another problematic item could be a film which starts out strong, but goes on for too long. To ensure that multimedia content will remain of interest to the users, problematic content should be kept to a minimum.

Methods/features for user post review should be user friendly and readily available. A couple of examples of the methods/features for post review are the following (the names of these features are for illustrative purposes only, and any other name for any of these features can be chosen):
1. “Details editing form” feature enables the user to suggest other titles\descriptions for an item. After viewing an item, each user will be given the opportunity to suggest an alternative title\description for the item by choosing the appropriate icon. By choosing to do so, an appropriate form will be opened, and user will be asked to enter in their suggestions.
2. “Thumbnails suggestion” feature enables the user to choose an alternative thumbnail for an item. After viewing an item, the user will have the opportunity to suggest a thumbnail for the item. By choosing to do so, the user will get the option to choose the picture (according to their opinion) that best represents the item.
3. “Make the movie shorter” feature enables the user to give suggestions for shorter versions of an item. After viewing an item, the user will get the opportunity to define new start and finish points for the item.

For a post review suggestion made by a user the following process will be made. Both the original and the suggested versions of the item will be sent to a group of users. These users will get an appropriate message, telling them that a new version is suggested for this item and they are asked to choose the better version. The users' votes will be record in the main server or MCS. After getting enough votes (an amount decided by the system administrators) a calculation will be made in order to decide about the better suggestion. The better suggestion will be the one that will be distributed from then on.

This procedure is constant and can reoccur numerous times for each item and for each item's component. Correct definitions, as made by the system administrators, will minimize the occurrence of events like distributing several versions of the same item to the same user, and that only one version, which is the most updated and improved, will be distributed to the public.

There are several variables that can be set in order to make this process more efficient, including but not limited to:
1. min' number of votes for a suggested version—in order to be sure that enough users watched the suggested version and that the process's result will represent accurate\public opinion, a minimum amount of users has to take part in this process. We can assure this by defining a minimum number of votes required.
2. min' interval between suggestions votes (beyond a simple majority)—in order to be sure that a newly suggested version is truly better then the previous one, a minimum interval of votes between the suggested version and the votes for keeping the original can be set. For example—if a total of 1000 votes are cast, and a minimum interval of 200 votes is required. In this case, if the original version received 450 votes and the suggested version received 550 votes, the original version will stay the distributed one. However, once the gap increases beyond 200 votes, the suggested version will take the place of the original one.

There are many other variables that can be combined in this process in order to make it more accurate and efficient. The right variables will be selected by the system's administrators according to the company's requirements.

While certain features of the disclosure have been illustrated and described herein, many modifications, substitutions, changes, and equivalents will now occur to those skilled in the art. It is, therefore, to be understood that the appended claims are intended to cover all such modifications and changes as fall within the true spirit of the disclosure.

What is claimed is:

1. A method of post review of content items previously posted on a shared network resource, comprising:
receiving a suggestion from a viewer with respect to a proposed change to a previously posted content item and submitting said suggestion to a control group for a ratification vote of the proposed change to said previously posted content item.

2. The method according to claim 1, wherein said suggestion comprises a change in the title of said previously posted content item.

3. The method according to claim 1, wherein said suggestion comprises a change in the length of said previously posted content item.

4. The method according to claim 1, wherein said suggestion comprises a change in the thumbnail that represents said previously posted content item.

5. The method according to claim 1, wherein said suggestion are submitted by said viewer through an online form.

6. The method according to claim 1, wherein said suggestion and said previously posted content item are sent to said control group, and wherein said control group is requested to view said previously posted content item and said suggestion and are asked to choose by said ratification vote which version they prefer.

7. The method according to claim 1, wherein said verification vote requires a minimum number of votes to ensure an accurate representation of public opinion.

8. The method according to claim 1, wherein said verification vote requires a simple majority to make a change in said previously posted content item.

9. The method according to claim 1, wherein said verification vote requires a predefined majority to make a change in said previously posted content item.

10. The method according to claim 1, wherein a voter is part of a control group consisting of reviewers.

11. The method according to claim 10, wherein reviewers are pre-selected clients.

12. The method according to claim 10, wherein reviewers are clients volunteering to serve as reviewers.

13. A system for post review of content items previously posted on a shared network resource, comprising:
a media content sorter adapted to receive from one or more voters voting values for a proposed change in a previously posted content item and to replace a changed content item with said a previously posted content item if said voting values comply with a predefined policy.

14. The system according to claim 13, wherein said proposed change comprises a change in the title of said previously posted content item.

15. The system according to claim 13, wherein said proposed change comprises a change in the length of said previously posted content item.

16. The system according to claim 13, wherein said proposed change comprises a change in the thumbnail that represents said previously posted content item.

17. The system according to claim 13, wherein said proposed change is submitted by said viewer through an online form.

18. The system according to claim 13, wherein said proposed change and said previously posted content item are sent to said control group, and wherein said control group is requested to view said previously posted content item and said proposed change and are asked to choose by said ratification vote which version they prefer.

19. The system according to claim 13, wherein said verification vote requires a minimum number of votes to ensure an accurate representation of public opinion.

20. The system according to claim 13, wherein said voting values requires a majority voting for a changed content item to make a change in said previously posted content item.

21. The system according to claim 13, wherein said voting values requires a predefined majority to make a change in said previously posted content item.

22. The system according to claim 13, wherein a voter is part of a control group consisting of reviewers.

23. The system according to claim 22, wherein reviewers are pre-selected clients.

24. The system according to claim 22, wherein reviewers are clients volunteering to serve as reviewers.
